(19) United States
(12) Patent Application Publication
(10) Pub. No.: US 2023/0152119 A1
(43) Pub. Date: May 18, 2023

(54) SYSTEM FOR GUIDING EVACUATION AT A TIME OF A DISASTER, METHOD FOR GUIDING EVACUATION AT A TIME OF A DISASTER, AND NON-TRANSITORY COMPUTER-READABLE MEDIUM

(71) Applicant: TOYOTA JIDOSHA KABUSHIKI KAISHA, Toyota-shi (JP)

(72) Inventors: Fumihiro KONNO, Suntou-gun (JP); Takahiro KATO, Toyota-shi (JP)

(73) Assignee: TOYOTA JIDOSHA KABUSHIKI KAISHA, Toyota-shi (JP)

(21) Appl. No.: 17/949,480

(22) Filed: Sep. 21, 2022

(30) Foreign Application Priority Data
Nov. 12, 2021 (JP) 2021-185026

(51) Int. Cl. G01C 21/36; B60W 40/064

(52) U.S. Cl. CPC G01C 21/3691; G01C 21/3697; B60W 40/064

(57) ABSTRACT

A system for guiding evacuation at a time of a disaster, including: a wireless communicator installed at a vehicle and is able to receive information relating to occurrence of a disaster from an external communication device; a display installed at the vehicle and that is able to display information; a notification device installed at the vehicle and that is able to notify an occupant of the vehicle of information; and a processor coupled to a memory, the processor is configured to: in response to information expressing that a disaster has occurred being received from the wireless communicator, propose a traveling route to a destination of the vehicle, and cause the display to display the destination and the traveling route, and cause the notification device to notify the vehicle occupant of information relating to a status of crowding of at least one of the destination and the traveling route.

### CROSS-REFERENCE TO RELATED APPLICATION

This application claims priority under 35 USC 119 from Japanese Patent Application No. 2021-185026, filed on Nov. 12, 2021, the disclosure of which is incorporated by reference herein.

### BACKGROUND

### Technical Field

The present disclosure relates to a system for guiding evacuation at a time of a disaster, a method for guiding evacuation at a time of a disaster, and a non-transitory computer-readable medium storing a program.

### Related Art

Japanese Patent Application Laid-Open (JP-A) No. 2009-122004 discloses a navigation system that sets a route to an emergency shelter at the time when a situation requiring emergency evacuation arises in a geographical region in which a vehicle is traveling.

In the navigation system of JP-A No. 2009-122004, there is room for improvement in setting the traveling route to an emergency shelter that is suitable for the occupant of the vehicle.

### SUMMARY

The present disclosure provides a system for guiding evacuation at a time of a disaster, a method for guiding evacuation at a time of a disaster, and a non-transitory computer-readable medium storing a program, by which an occupant of a vehicle may set a destination and a traveling route to the destination that are suitable for him/her.

A first aspect of the present disclosure is a system for guiding evacuation at a time of a disaster, including: a memory; a wireless communicator that is installed at a vehicle and that is able to receive information relating to occurrence of a disaster from an external communication device; a display that is installed at the vehicle and that is able to display information; a notification device that is installed at the vehicle and that is able to notify an occupant of the vehicle of information; and a processor coupled to the memory, the processor is configured to: in response to information expressing that a disaster has occurred being received from the wireless communicator, propose a traveling route to a destination of the vehicle, and cause the display to display the destination and the traveling route, and cause the notification device to notify the vehicle occupant of information relating to a status of crowding of at least one of the destination and the traveling route.

When information expressing that a disaster has occurred is received from the wireless communicator, the processor of the system for guiding evacuation at a time of a disaster of a first aspect of the present disclosure proposes a traveling route to a destination of the vehicle, and causes the display to display the destination and the traveling route. Moreover, the processor causes the notification device to notify the vehicle occupant of information relating to the status of crowding of at least one of the proposed destination and traveling route. Therefore, on the basis of information from the display, the vehicle occupant recognizes the proposed destination and traveling route, and, on the basis of the information from the notification device, the vehicle occupant can recognize the statuses of crowding of the destination and the traveling route. Accordingly, the vehicle occupant may set a destination and a traveling route that are suitable for him/her.

In a second aspect of the present disclosure, in the above-described first aspect, the notification device may be the display.

In the second aspect of the present disclosure, on the basis of the information displayed on the display, the vehicle occupant may grasp the destination and the traveling route, and the status of crowding of at least one of the destination and the traveling route.

In a third aspect of the present disclosure, in the above-described first or second aspect, the processor may be configured to propose a plurality of destinations and a plurality of traveling routes.

In the third aspect of the present disclosure, the processor may propose plural destinations and traveling routes. Therefore, the vehicle occupant may, upon understanding the statuses of crowding, set a destination and a traveling route that are suitable for him/her from among plural destinations and traveling routes.

A fourth aspect of the present disclosure, tin he system of any of the above-described aspects, may further include: an external server that communicates wirelessly with another vehicle, wherein the processor may be configured to: cause vehicle information, which is at least one of sensor information acquired by a sensor provided at the other vehicle or operation information of a movable device provided at the other vehicle, to be transmitted by the wireless communicator to the external server by wireless communication, and cause the notification device to notify the vehicle occupant of weather related information of a periphery of the another vehicle that is estimated on the basis of the vehicle information received by the external server.

In the fourth aspect of the present disclosure, vehicle information of another vehicle is transmitted to an external server by the wireless communicator. Moreover, the notification device notifies the vehicle occupant of weather related information of the periphery of the another vehicle that is estimated on the basis of the vehicle information received by the external server. Therefore, the vehicle occupant can set the destination and traveling route that are suitable for him/her, on the basis of the weather related information reported by the notification device.

In a fifth aspect of the present disclosure, in the above-described fourth aspect, the sensor information may include at least one of image information acquired by a camera provided at the vehicle or information relating to slip ratios of wheels of the vehicle that is acquired on the basis of detected values of wheel speed sensors, and the operation information may include at least one of operation information of a wiper device provided at the vehicle or operation information of an anti-lock brake system provided at the vehicle.

In the fifth aspect of the present disclosure, the weather related information is estimated on the basis of at least one of image information acquired by the camera, information relating to the slip ratios of the wheels acquired on the basis of detected values of wheel speed sensors, operation information of the wiper device, and operation information of the anti-lock brake system. Therefore, the weather related information is highly accurate.

In a sixth aspect of the present disclosure, in the above-described aspects, the processor may be configured to, after the destination and the traveling route have been proposed, newly propose the destination and the traveling route on the basis of information relating to occurrence of a disaster that the wireless communicator receives from the external communication device.

In the sixth aspect of the present disclosure, the processor may, after the destination and the traveling route have been proposed, newly propose a destination and a traveling route on the basis of information relating to the occurrence of a disaster that the wireless communicator receives from the external communication device. Therefore, the vehicle occupant may set a destination and a traveling route that are suitable for him/her, on the basis of the latest disaster information.

A seventh aspect of the present disclosure is a method for guiding evacuation at a time of a disaster, wherein a processor: proposes a traveling route to a destination of a vehicle in response to a wireless communicator installed in the vehicle receiving information relating to occurrence of a disaster from an external communication device; causes a display installed in the vehicle to display the destination and the traveling route; and causes a notification device installed in the vehicle to notify an occupant of the vehicle of information relating to a status of crowding of at least one of the destination and the traveling route.

An eighth aspect of the present disclosure is a non-transitory computer-readable medium on which is recorded a program that is executable by a processor to perform processing that includes: in response to a wireless communicator installed at a vehicle receiving information relating to occurrence of a disaster from an external communication device, proposing a traveling route to a destination of the vehicle, and causing a display installed at the vehicle to display the destination and the traveling route, and causing a notification device installed at the vehicle to notify an occupant of the vehicle of information relating to a status of crowding of at least one of the destination and the traveling route.

In accordance with the above-described aspects, in the system for guiding evacuation at a time of a disaster, the method for guiding evacuation at a time of a disaster, and the program to the present disclosure, the occupant of a vehicle may set a destination and a traveling route to the destination that are suitable for him/her.

### BRIEF DESCRIPTION OF THE DRAWINGS

Exemplary embodiments will be described in detail based on the following figures, wherein:

FIG. 1 is a drawing illustrating a system for guiding evacuation at a time of a disaster relating to an exemplary embodiment;

FIG. 2 is a control block drawing of an ECU of a vehicle and an external server that are illustrated in FIG. 1;

FIG. 3 is a functional block drawing of the ECU illustrated in FIG. 2;

FIG. 4 is a functional block drawing of the external server illustrated in FIG. 1;

FIG. 5 is a drawing illustrating a map image of a periphery of the vehicle that is displayed on a display of the vehicle;

FIG. 6 is a drawing illustrating the map image at the time when a traveling route is set;

FIG. 7 is a drawing illustrating the map image at the time when a new disaster occurs;

FIG. 8 is a drawing illustrating the map image at the time when a new traveling route is proposed;

FIG. 9 is a drawing illustrating the map image at the time when a traveling route is reset;

FIG. 10 is a flowchart illustrating processing executed by the external server;

FIG. 11 is a flowchart illustrating processing executed by the ECU; and

FIG. 12 is a flowchart illustrating processing executed by the ECU.

### DETAILED DESCRIPTION

Exemplary embodiments of a system for guiding evacuation at a time of a disaster, a method for guiding evacuation at a time of a disaster, and a program relating to the present disclosure are described hereinafter with reference to the drawings.

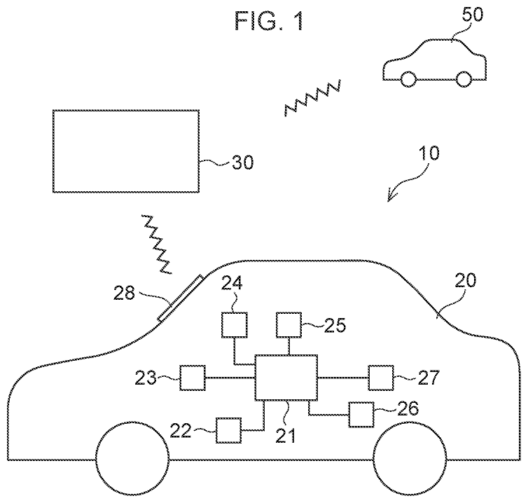

As illustrated in FIG. 1, a system 10 for guiding evacuation at a time of a disaster of the present exemplary embodiment has a vehicle 20, a vehicle 50 (hereinafter called another vehicle 50) that is other than the vehicle 20, and an external server 30. Although one another vehicle 50 is illustrated in FIG. 1, there are actually a plurality of the another vehicles 50.

As illustrated in FIG. 1, the vehicle 20, which can communicate data with the external server 30 via a network (e.g., the internet), has an ECU (Electronic Control Unit) 21, a display (notification device) 22 having a touch panel, a speaker (notification device) 23, a camera (sensor) 24, a GPS (Global Positioning System) receiver 25, wheel speed sensors (sensors) 26, a brake device (movable member) 27, and a wiper device (movable member) 28. A vehicle ID is given to the vehicle 20. The display 22, the speaker 23, the camera 24, the GPS receiver 25, the wheel speed sensors 26, the brake device 27 and the wiper device 28 are connected to the ECU 21. Note that, although not illustrated in FIG. 1, the another vehicle 50 also has the ECU 21, the display 22, the speaker 23, the camera 24, the GPS receiver 25, the wheel speed sensors 26, the brake device 27 and the wiper device 28. Moreover, a vehicle ID is given to each of the another vehicles 50.

As will be described later, the display 22 can display various images. The speaker 23 can output various sounds. The camera 24 can capture images of subjects positioned at the periphery of the vehicle 20. The GPS receiver 25 acquires information relating to the position at which the vehicle 20 is traveling (hereinafter called “position information”) by receiving GPS signals transmitted from GPS satellites. The wheel speed sensors 26 detect the wheel speeds of the four wheels (not illustrated) of the vehicle 20. The brake device 27 applies braking force to the four wheels when the brake pedal (not illustrated) is depressed. Moreover, the brake device 27 is a portion of an anti-lock brake system (hereinafter called ABS) that is installed in the vehicle 20. The wiper device 28 moves reciprocatingly on the front windshield by the driving force of an actuator when an unillustrated wiper switch is operated so as to be turned on.

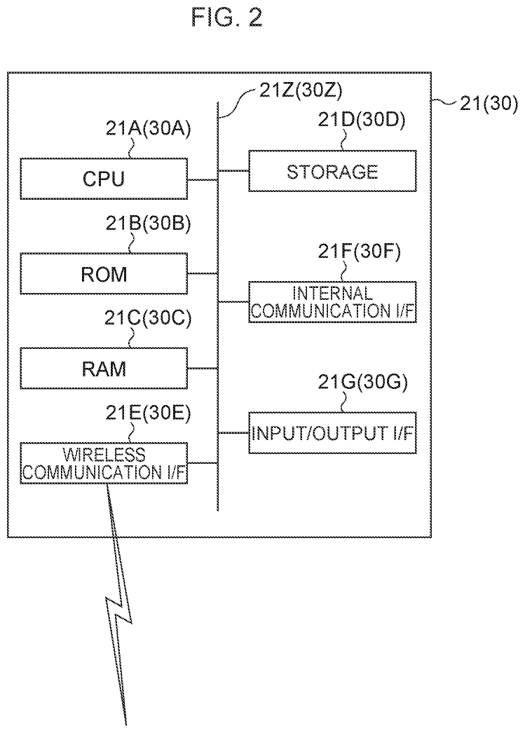

As illustrated in FIG. 2, the ECU 21 is configured to include a CPU (Central Processing Unit) (processor) 21A, a ROM (Read Only Memory) 21B, a RAM (Random Access Memory) 21C, a storage 21D, a wireless communication I/F (interface) (wireless communicator) 21E, an internal communication I/F 21F, and an input/output I/F 21G. The CPU 21A, the ROM 21B, the RAM 21C, the storage 21D, the wireless communication I/F 21E, the internal communication I/F 21F and the input/output I/F 21G are connected so as to be able to communicate with one another via internal bus 21Z. The ECU 21 can acquire information relating to the time from a timer. The display 22, the speaker 23, the camera 24, the GPS receiver 25, the wheel speed sensors 26, the brake device 27 and the wiper device 28 are connected to the ECU 21 (the input/output I/F 21G).

The CPU 21A is a central computing processing unit, and executes various programs and controls the respective sections. The CPU 21A reads-out programs from the ROM 21B or the storage 21D, and executes the programs by using the RAM 21C as a workspace. The CPU 21A controls the respective configurations and carries out various computing processings in accordance with the programs recorded in the ROM 21B or the storage 21D.

The ROM 21B stores various programs and various data. For example, plural applications (programs) are installed in the ROM 21B. A navigation application for example is installed in the ROM 21B. Namely, the vehicle 20 is equipped with a navigation system. The RAM 21C temporarily stores programs and data as a workspace. The storage 21D is configured by a storage device such as an HDD (Hard Disk Drive) or an SSD (Solid State Drive) or the like, and stores various programs and various data. For example, map data of the entire country in which the vehicle 20 is located is recorded in the storage 21D.

The wireless communication I/F 21E is an interface for communicating wirelessly with various equipment. For example, the wireless communication I/F 21E can communicate wirelessly with the external server 30. Communication standards such as Bluetooth, Wi-Fi, or the like are used at the wireless communication I/F 21E.

The internal communication I/F 21F is an interface for connection, via an external bus, with ECUs other than the ECU 21 that is provided at the vehicle 20.

The input/output I/F 21G is an interface for communication with various devices. For example, the input/output I/F 21G can communicate with the display 22, the speaker 23, the camera 24, the GPS receiver 25, the wheel speed sensors 26, the brake device 27 and the wiper device 28.

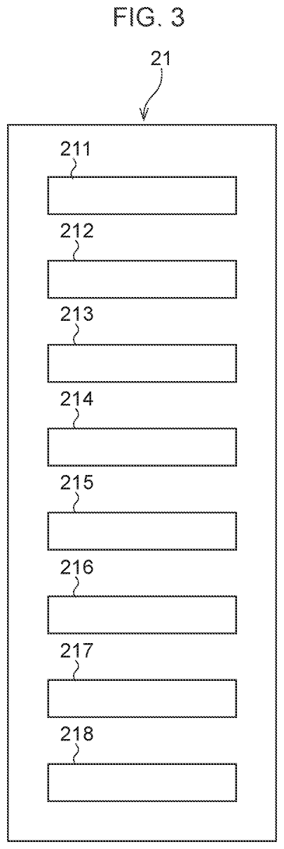

An example of functional configurations of the ECU 21 is illustrated in a block drawing in FIG. 3. The ECU 21 has, as the functional configurations thereof, a display control section 211, a speaker control section 212, a navigation processing section 213, a route setting section 214, an information recognizing section 215, a brake control section 216, a wiper control section 217, and a transmitting/receiving control section 218. The display control section 211, the speaker control section 212, the navigation processing section 213, the route setting section 214, the information recognizing section 215, the brake control section 216, the wiper control section 217, and the transmitting/receiving control section 218 are realized by the CPU 21A reading-out a program that is stored in the ROM 21B and executing the program.

The display control section 211 controls the display 22. As will be described later, map images of the navigation system and the like are displayed on the display 22.

The speaker control section 212 controls the speaker 23.

The navigation processing section 213 executes navigation processing. For example, the navigation processing section 213 can execute the usual route-searching processing when a touch-operation is carried out at the display 22 (the touch panel) in a state in which a navigation application has been started. Namely, the navigation processing section 213 can execute searching for routes that are from the current position of the vehicle 20 to the destination inputted by the touch-operation of a vehicle occupant. Moreover, the navigation processing section 213 acquires traffic information that includes information relating to traffic signs, and speed limits of the roads, of the geographical region that includes the place where the vehicle 20 is located. The acquired information is displayed on the display 22 that is controlled by the display control section 211.

Moreover, the navigation processing section 213 has at least the functions of the main control section, the emergency evacuation judging section, the emergency shelter specifying section, the route searching section, and the route guiding section of the computing processing section of JP-A No. 2009-122004. Namely, the functions of the navigation processing section 213 are known, and JP-A No. 2009-122004 is incorporated by reference into the present specification. Namely, when disaster information is included in the road traffic information received from the external server 30, the navigation processing section 213 proposes a traveling route for guiding the vehicle 20 to a shelter (an emergency shelter) while avoiding the place where the disaster has occurred. Note that disasters in the present exemplary embodiment include, for example, earthquakes, landslides, floods, tsunamis, and tornados. At this time, the navigation processing section 213 can propose plural shelters (destinations) and traveling routes to the respective shelters. The proposed shelters and traveling routes to the respective shelters are displayed on the display 22 that is controlled by the display control section 211.

When a vehicle occupant executes a route setting operation with respect to the display 22 (the touch panel), the route setting section 214 sets one of the proposed traveling routes as the traveling route on which the vehicle 20 will travel. The set traveling route is displayed on the display 22 that is controlled by the display control section 211.

When the wireless communication I/F 21E receives, from the external server 30, disaster information of the geographical region in which the vehicle 20 is located, information relating to the statuses of crowding of shelters, information relating to the traffic congestion statuses of roads in that geographical region, and weather related information that is described later, the information recognizing section 215 recognizes these information. Hereinafter, the information relating to the statuses of crowding of shelters and the information relating to the traffic congestion statuses of the roads are collectively called “crowding information”. These information that have been recognized by the information recognizing section 215 are displayed on the display 22 that is controlled by the display control section 211.

The brake control section 216 controls the brake device 27 when the brake pedal is depressed. Moreover, on the basis of information relating to the wheel speeds of the four wheels that are transmitted from the four wheel speed sensors 26, the brake control section 216 computes the slip ratio (=(vehicle body speed−wheel speed)/vehicle body speed) of each wheel. Further, the brake control section 216 operates the ABS when the computed slip ratio exceeds a predetermined threshold value.

When the aforementioned wiper switch is operated so as to be turned on, the wiper control section 217 cause the aforementioned actuator to operate. Due thereto, the wiper device 28 operates. On the other hand, when the wiper switch is operated so as to be turned off, the wiper control section 217 stops the actuator. Due thereto, the wiper device 28 stops operating.

The transmitting/receiving control section 218 controls the wireless communication I/F 21E and the internal communication I/F 21F. For example, the transmitting/receiving control section 218 wirelessly transmits various information to the external server 30 via the wireless communication I/F 21E, and causes the wireless communication I/F 21E to receive various information that are wirelessly transmitted from the external server 30. For example, the transmitting/receiving control section 218 wirelessly transmits vehicle information of the vehicle 20 (the another vehicle 50) to the external server 30. The vehicle information of the present exemplary embodiment includes image data (image information) acquired by the camera 24 of the vehicle 20 (the another vehicle 50), position information of the vehicle 20 (the another vehicle 50) acquired by the GPS receiver 25, slip ratio information acquired by the brake control section 216 on the basis of the detected values of the wheel speed sensors 26, operation information of the ABS acquired by the brake control section 216, and operation information of the wiper device 28 acquired by the wiper control section 217. Note that the image data (image information) and slip ratio information are “sensor information”, and the operation information of the ABS and the operation information of the wiper device 28 are “operation information”.

As illustrated in FIG. 2, the external server 30 illustrated in FIG. 1 is configured to include, as the hardware configurations thereof, a CPU (processor) 30A, a ROM 30B, a RAM 30C, a storage 30D, a wireless communication I/F 30E, an internal communication I/F 30F and an input/output I/F 30G. The CPU 30A, the ROM 30B, the RAM 30C, the storage 30D, the wireless communication I/F 30E, the internal communication I/F 30F and the input/output I/F 30G are connected so as to be able to communicate with one another via an internal bus 30Z. The external server 30 can acquire information relating to the time from a timer.

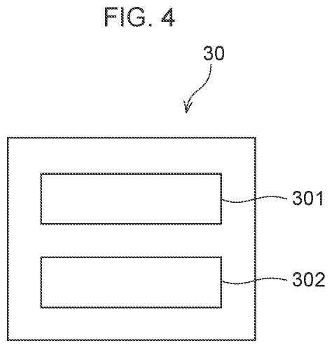

An example of the functional configurations of the hardware of the external server 30 are illustrated in a block drawing in FIG. 4. The hardware of the external server 30 has an estimating section 301 and a transmitting/receiving control section 302 as the functional configurations. The estimating section 301 and the transmitting/receiving control section 302 are realized by the CPU 30A reading-out a program that is stored in the ROM 30B and executing the program.

The sensor information and the operation information of the vehicle 20 and the another vehicle 50 are, while associated with the position information and the ID information of the vehicle 20 and the another vehicle 50, wirelessly transmitted from the vehicle 20 and the another vehicle 50 to the external server 30. On the basis of the sensor information and the operation information of the vehicle 20 and the another vehicle 50, the estimating section 301 estimates weather related information of the respective geographical regions in which the vehicle 20 and the another vehicle 50 are located. For example, when information, which expresses that the wiper device 28 has been operated continuously for a predetermined time period or more by the wiper control section 217, is transmitted from one of the another vehicles 50 via the external server 30 to the vehicle 20, the estimating section 301 determines that it is raining in the geographical region in which that another vehicle 50 is located. Further, when information, which expresses that the ABS has been operated a predetermined number of times or more within a predetermined time period by the brake control section 216, is transmitted from one of the another vehicles 50 via the external server 30 to the vehicle 20, the estimating section 301 determines that slippage is occurring often on the road surfaces of the roads of the geographical region in which that another vehicle 50 is located. Further, when snow is included in the image data acquired by the camera 24 of one of the another vehicles 50, the estimating section 301 determines that the road surfaces of the roads of the geographical region in which that another vehicle 50 is located are in states in which it is easy for slipping to occur.

The transmitting/receiving control section 302 controls the wireless communication I/F 30E and the internal communication I/F 30F. As will be described later, for example, the transmitting/receiving control section 302 wirelessly transmits various information to the vehicle 20 via the wireless communication I/F 30E, and causes the wireless communication I/F 30E to receive various information that are wirelessly transmitted from the vehicle 20. Moreover, the transmitting/receiving control section 302 receives disaster information and crowding information of the geographical region in which the vehicle 20 is located, which are wirelessly transmitted from a server (not illustrated) of a local government that is managed by the local government of that geographical region. As described above, the crowding information includes information relating to statuses of crowding of shelters and information relating to congestion statuses of the roads.

Operation of the present exemplary embodiment are described next.

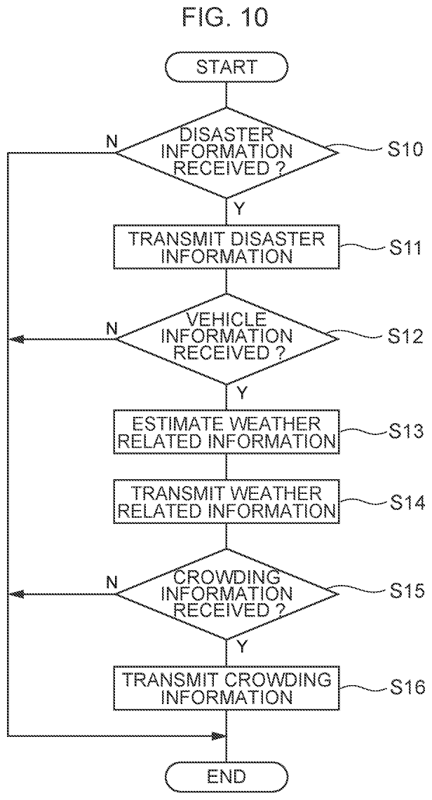

First, the flow of the processing that the external server 30 carries out is described by using the flowchart of FIG. 10. The external server 30 repeatedly executes the processing of the flowchart of FIG. 10 each time a predetermined time period elapses.

First, in step S10, the transmitting/receiving control section 302 of the external server 30 determines whether or not the wireless communication I/F 30E has received disaster information relating to the geographical region in which the vehicle 20 is located from the aforementioned server of the local government.

The external server 30 that has made an affirmative determination in step S10 moves on to step S11, and the transmitting/receiving control section 302 causes the wireless communication I/F 30E to wirelessly transmit the received disaster information.

The external server 30 that has finished the processing of step S11 moves on to step S12, and determines whether or not the aforementioned vehicle information has been received from at least one of the vehicle 20 and the another vehicle 50.

The external server 30 that has made an affirmative determination in step S12 moves on to step S13, and the estimating section 301, on the basis of the received vehicle information, estimates the weather related information of each geographical region in which at least one of the vehicle 20 and the another vehicle 50 is located.

The external server 30 that has finished the processing of step S13 moves on to step S14, and the transmitting/receiving control section 302 causes the wireless communication I/F 30E to wirelessly transmit the estimated weather related information.

The external server 30 that has finished the processing of step S14 moves on to step S15, and determines whether or not crowding information of the geographical region in which the vehicle 20 is located has been received from the aforementioned server of the local government.

The external server 30 that has made an affirmative determination in step S15 moves on to step S16, and the transmitting/receiving control section 302 causes the wireless communication I/F 30E to wirelessly transmit the received crowding information.

When the processing of step S16 ends, or when there is a negative determination in step S10, S12 or S15, the external server 30 ends the processing of the flowchart of FIG. 10 for the time being.

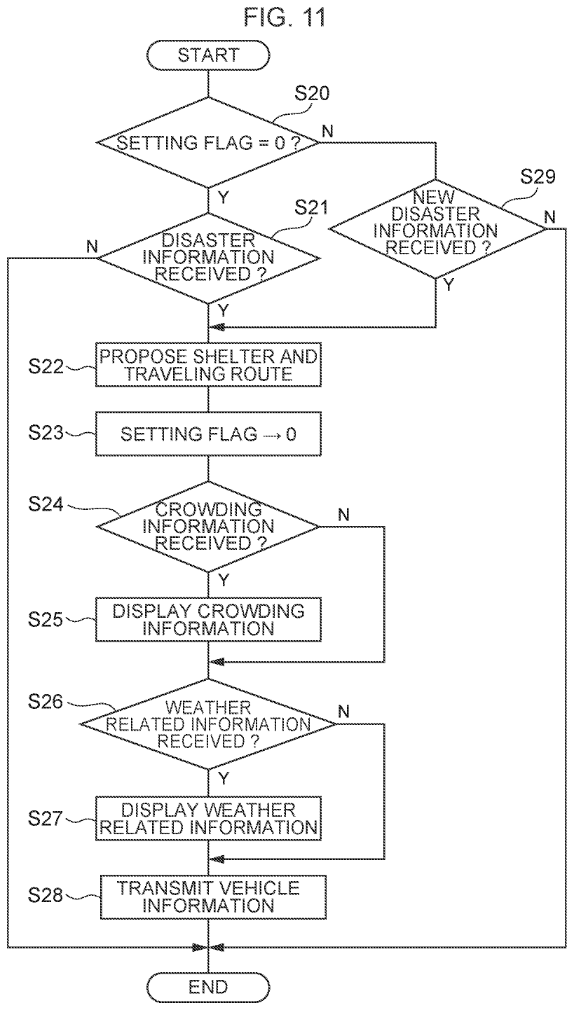

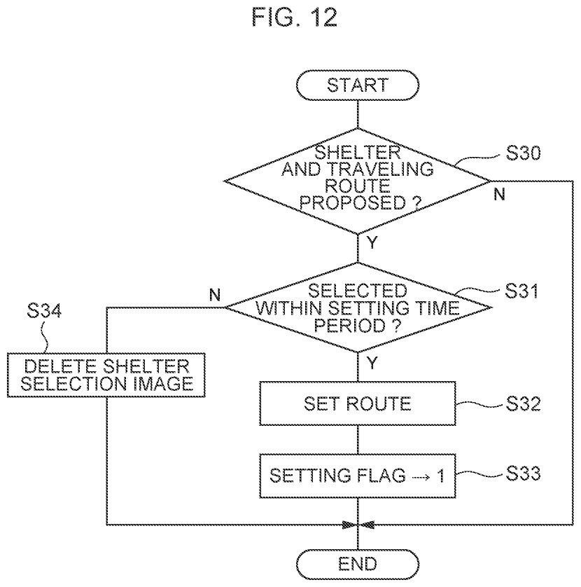

The flow of the processing that the ECU 21 carries out is described next by using the flowcharts of FIG. 11 and FIG. 12. The flowchart of FIG. 11 is described first. The ECU 21 repeatedly executes the processing of the flowchart of FIG. 11 each time a predetermined time period elapses.

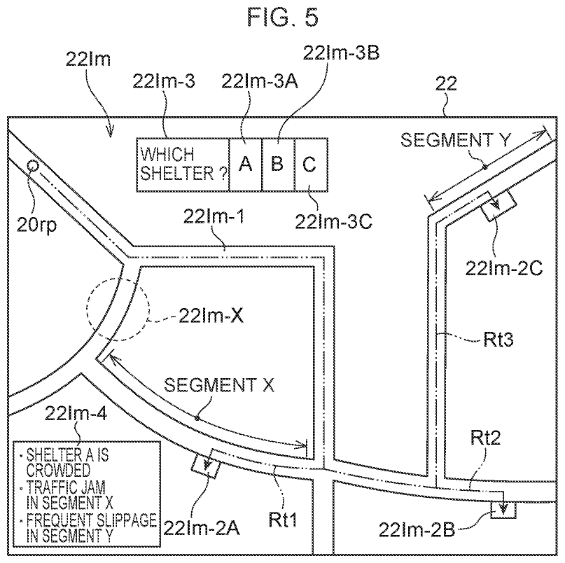

Note that, in the following description, it is assumed that the navigation application of the vehicle 20 has been started. Therefore, as illustrated in FIG. 5 through FIG. 9, map image 221m, which shows geographical information of the geographical region in which the vehicle 20 is located, is being displayed on the display 22 of the vehicle 20. Road images 221m-1 illustrating roads, and images 221m-2A, 221m-2B, 221m-2C illustrating three shelters A, B, C respectively, are included in the map image 221m illustrated in FIG. 5 through FIG. 9. Note that the circular mark denoted by reference numeral 2Orp in FIG. 5 through FIG. 9 is the current position of the vehicle 20 that is based on the position information of the vehicle 20.

First, in step S20, the route setting section 214 of the ECU 21 determines whether or not the value of a setting flag is “0”. Note that the initial value of the setting flag is “0”.

The ECU 21 that has made an affirmative determination in step S20 moves on to step S21, and the information recognizing section 215 determines whether or not the wireless communication I/F 21E has received disaster information from the external server 30.

The ECU 21 that has made an affirmative determination in step S21 moves on to step S22, and the navigation processing section 213 proposes a traveling route for guiding the vehicle 20 to a shelter, while avoiding the place where a disaster has occurred. For example, as illustrated in FIG. 5, a case is assumed in which a tornado has occurred on a part of a road. The circular chain line shown in FIG. 5 is tornado image 221m-X. In this case, while taking into consideration the current position 20rp of the vehicle 20, the position of the tornado and the positions of the shelters A, B, C, the navigation processing section 213 proposes shelters and traveling routes the vehicle 20 can be led to and led along, while avoiding the place where the tornado occurred. In this case, the navigation processing section 213 proposes three shelters (shelters A, B, C) and three traveling routes. Note that three traveling routes Rt1, Rt2, Rt3 are shown by the imaginary lines in FIG. 5. Namely, in this case, the navigation processing section 213 determines that the vehicle 20 can be guided to the shelters A, B, C while avoiding the tornado. In this case, as illustrated in FIG. 5, a shelter selection image 221m-3 is displayed on the display 22. On the basis of the situation of the occurrence of the disaster, the navigation processing section 213 can select, as the shelter, a predetermined place or facility that is included in the map image 221m. For example, when a tornado occurs, a tunnel can be selected as the shelter. Further, in a case in which a predetermined place or facility is designated as the shelter in the map image 221m, the navigation processing section 213 can select that place or facility as the shelter. Therefore, as illustrated in FIG. 5, the display 22 that is controlled by the display control section 211 displays the shelter selection image 221m-3.

The ECU 21 that has finished the processing of step S22 moves on to step S23, and the route setting section 214 sets the value of the setting flag to “0”.

The ECU 21 that has finished the processing of step S23 moves on to step S24, and the information recognizing section 215 determines whether or not the wireless communication I/F 21E has received, from the external server 30, crowding information relating to the geographical region in which the vehicle 20 is located.

The ECU 21 that has made an affirmative determination in step S24 moves on to step S25. Here, a case is assumed in which information expressing that “shelter A is crowded”, and information expressing that “there is a traffic jam in segment X of the roads shown in FIG. 5 through FIG. 9”, are included in the crowding information. In this case, in step S25, the display 22 that is controlled by the display control section 211 displays information display image 221m-4 that shows the crowding information and the weather related information.

The ECU 21 that has finished the processing of step S25 moves on to step S26, and the information recognizing section 215 determines whether or not the wireless communication I/F 21E has received, from the external server 30, the weather related information relating to the geographical region in which the vehicle 20 is located.

The ECU 21 that has made an affirmative determination in step S26 moves on to step S27. Here, a case is assumed in which information expressing that “slipping is occurring often in segment Y of the roads shown in FIG. 5 through FIG. 9” is included in the weather related information. In this case, this information is added to the information display image 221m-4.

The ECU 21 that has finished the processing of step S27 moves on to step S28, and the wireless communication I/F 21E that is controlled by the transmitting/receiving control section 218 wirelessly transmits the vehicle information of the vehicle 20 to the external server 30.

When the processing of step S28 ends, or if the determination in step S21 or S29 is negative, the ECU 21 ends the processing of the flowchart of FIG. 11 for the time being. Note that the processing of step S29 is described later.

The flowchart of FIG. 12 is described next.

First, in step S30, the route setting section 214 of the ECU 21 determines whether or not a proposal for a shelter and a traveling route has been given by the navigation processing section 213.

The ECU 21 that has made an affirmative determination in step S30 moves on to step S31. In step S31, the ECU 21 determines whether or not a vehicle occupant has carried out a touch-operation with respect to any one of A selection image 221m-3A, B selection image 221m-3B and C selection image 221m-3C that are portions of the shelter selection image 221m-3, within a predetermined time period from the point in time when the display of the shelter selection image 221m-3 started. As described above, shelter A is crowded, and there is a traffic jam in segment X. Moreover, slipping is occurring often in segment Y. Therefore, an occupant of the vehicle 20 himself/herself decides that the vehicle 20 should head to shelter B. Therefore, in step S31, the vehicle occupant carries out a touch-operation with respect to the B selection image 221m-3B within the predetermined time period. Accordingly, the route setting section 214 of the ECU 21 makes an affirmative determination in step S31, and moves on to step S32.

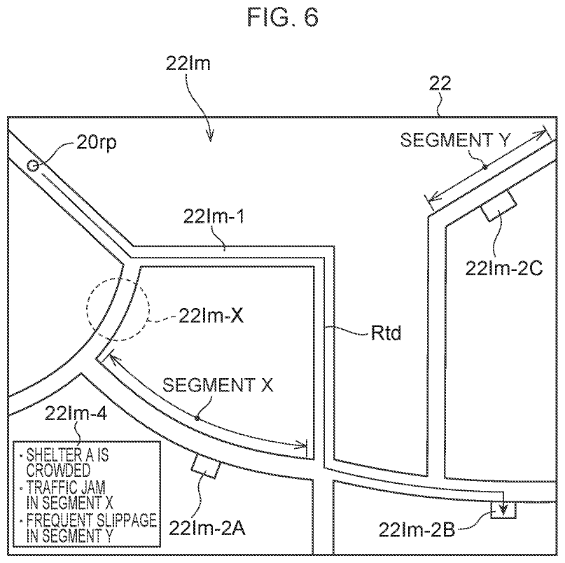

The route setting section 214 of the ECU 21 that has moved on to step S32 sets (decides upon) the traveling route to shelter B as the traveling route of the vehicle 20. At this time, as shown by the solid line in FIG. 6, only the traveling route Rt2 to shelter B is displayed on the display 22 as selected traveling route Rtd, and the traveling routes Rt1, Rt3 to shelters A, C are deleted from the display 22. Moreover, the shelter selection image 221m-3 is deleted from the display 22.

The ECU 21 that has finished the processing of step S32 moves on to step S33, and the route setting section 214 determines that the value of the setting flag is “1”.

Note that, in the case of a negative determination in step S31, the ECU 21 moves on to step S34. In this case, the display control section 211 deletes the three proposed traveling routes and the shelter selection image Im-3 from the display 22.

When the processings of steps S33 and S34 have ended, the ECU 21 ends the processing of the flowchart of FIG. 12 for the time being.

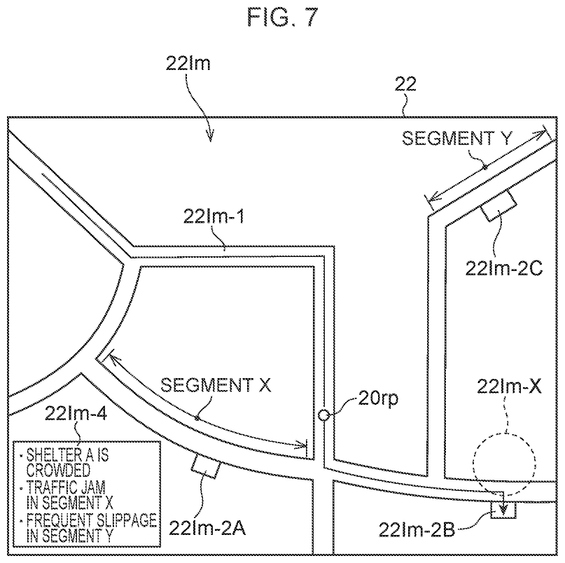

Next, a case is assumed in which the vehicle 20, which is traveling along the traveling route Rtd set in step S32, reaches the current position 20rp of FIG. 7, and a new tornado (the tornado image 221m-X) occurs in a vicinity of shelter B as illustrated in FIG. 7.

In this case, the ECU 21 makes a negative determination in step S20 of the flowchart of FIG. 11, and moves on to step S29. Moreover, in step S29, the information recognizing section 215 of the ECU 21 determines whether or not the wireless communication I/F 21E has received new disaster information from the external server 30.

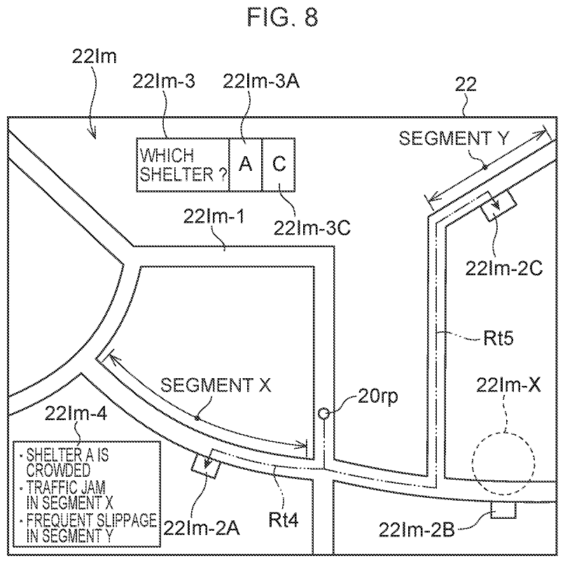

The ECU 21 that has made an affirmative determination in step S29 moves on to step S22, and the navigation processing section 213 proposes a traveling route for guiding the vehicle 20 to a shelter, while avoiding the place where the tornado has occurred. In this case, as illustrated in FIG. 8, the navigation processing system 213 proposes two shelters (shelters A, C) and two traveling routes Rt4, Rt5. Moreover, as illustrated in FIG. 8, the display 22 that is controlled by the display control section 211 displays the shelter selection image 221m-3.

Thereafter, in a case in which the ECU 21 carries out the processing of the flowchart of FIG. 12, the ECU 21 makes an affirmative determination in step S30, and moves on to step S31.

As described above, shelter A is crowded, and there is a traffic jam in segment X. Moreover, a new tornado has arisen in the vicinity of shelter B. Therefore, even though slipping is occurring often in segment Y, the occupant of the vehicle 20 himself/herself decides that the vehicle 20 should head to shelter C. Therefore, in step S31, the vehicle occupant carries out a touch-operation with respect to the C selection image 221m-3C within the predetermined time period. Accordingly, the ECU 21 makes an affirmative determination in step S31, and moves on to step S32.

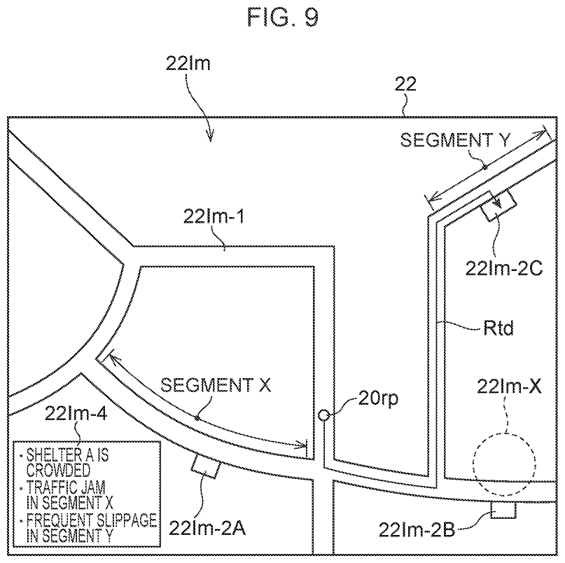

The route setting section 214 of the ECU 21 that has moved on to step S32 sets (decides upon) the traveling route Rt5 to shelter C as the traveling route Rtd of the vehicle 20. At this time, as shown by the solid line in FIG. 9, only the traveling route Rtd to shelter C is displayed on the display 22, and the traveling route Rt4 to shelter A is deleted from the display 22. Moreover, the shelter selection image 221m-3 is deleted from the display 22.

As described above, in the present exemplary embodiment, when information expressing that a disaster has occurred is received from the external server 30, the ECU 21 of the vehicle 20 proposes a traveling route that guides the vehicle 20 to a shelter while avoiding the place where the disaster has occurred, and causes the display 22 to display the proposed shelter (destination) and traveling route. Moreover, the display 22 displays information relating to the status of crowding of the proposed shelter, and information (traffic information) relating to the congestion status of the traveling route. Therefore, on the basis of the information from the display 22, the vehicle occupant recognizes the proposed shelter and traveling route, and, on the basis of the information from the display 22, the vehicle occupant can recognize the statuses of crowding of the shelter and the traveling route. Accordingly, the vehicle occupant can set a shelter and a traveling route that are suitable for him/her.

Moreover, in the present exemplary embodiment, the ECU 21 can propose plural shelters (destinations) and traveling routes. Therefore, the vehicle occupant can, upon grasping the statuses of crowding of the proposed shelters and traveling routes, set (decide upon) a shelter and a traveling route that are suitable for him/her from among the plural shelters and traveling routes.

Moreover, in the present exemplary embodiment, vehicle information of the vehicle 20 and the another vehicle 50 are respectively transmitted from the vehicle 20 and the another vehicle 50 to the external server 30, and, on the basis of the vehicle information, the external server 30 estimates the weather related information of the respective peripheries of the vehicle 20 and the another vehicle 50. Moreover, the weather related information that is estimated by the external server 30 is transmitted from the external server 30 to the vehicle 20 (the another vehicle 50). Therefore, a vehicle occupant of the vehicle 20 (the another vehicle 50) can, on the basis of the weather related information reported by the display 22, set a shelter and a traveling route that are suitable for him/her.

Moreover, in the present exemplary embodiment, when, after a shelter and a traveling route have been proposed from the ECU 21, the vehicle 20 receives new disaster information from the external server 30, the ECU 21 newly proposes a shelter and a traveling route. Therefore, the occupant of the vehicle 20 can set a shelter and a traveling route that are suitable for him/her, on the basis of the latest disaster information.

The system for guiding evacuation at a time of a disaster, the method for guiding evacuation at a time of a disaster, and the program relating to an exemplary embodiment have been described above. However, the designs of the system for guiding evacuation at a time of a disaster, the method for guiding evacuation at a time of a disaster, and the program can be changed appropriately within a scope that does not depart from the gist of the present disclosure.

For example, the external server 30 may transmit, to the vehicle 20, information relating to the status of crowding of a proposed shelter or information relating to the congestion status of a proposed traveling route.

The notification device that notifies the vehicle occupant of the crowding information may be the speaker 23 that voice-outputs the crowding information.

A display (notification device) or a speaker (notification device) of a portable terminal (e.g., a smartphone) that can communicate wirelessly with the vehicle 20 may notify the vehicle occupant of the crowding information. Further, various images of the navigation system may be displayed on the display of a portable terminal in which a navigation application is installed. For example, the images shown in FIG. 5 through FIG. 9 may be displayed on the display of a portable terminal.

The above-described vehicle information may include only one of the sensor information and the operation information. Further, the sensor information may include only one of the image data (image information) and the slip ratio information. Further, the operation information may include only one of the operation information of the ABS and the operation information of the wiper device 28. Moreover, the above-described vehicle information may be information that is different from the image data (image information), the slip ratio information, the operation information of the ABS, and the operation information of the wiper device 28.

The ECU 21 of the vehicle 20 may have the same function as the estimating section 301. In this case, the ECU 21 estimates the weather related information on the basis of the vehicle information received from the external server 30.

The ECU 21 of the vehicle 20 may have the functions of the external server 30. In this case, the external server 30 is unnecessary, and the vehicle 20 directly receives the information that is transmitted wirelessly from the server of a local government.

Instead of the GPS receiver 25, the vehicle 20 may have a receiver that can receive information from satellites of a global navigation satellite system other than GPS (e.g., Galileo).

The ECU 21 may read-in map data from a web server, and display map images that are based on the map data on the display 22.

What is claimed is:

1. A system for guiding evacuation at a time of a disaster, comprising:
a memory;
a wireless communicator that is installed at a vehicle and that is able to receive information relating to occurrence of a disaster from an external communication device;
a display that is installed at the vehicle and that is able to display information;
a notification device that is installed at the vehicle and that is able to notify an occupant of the vehicle of information; and
a processor coupled to the memory, the processor is configured to:
in response to information expressing that a disaster has occurred being received from the wireless communicator, propose a traveling route to a destination of the vehicle, and cause the display to display the destination and the traveling route, and cause the notification device to notify the vehicle occupant of information relating to a status of crowding of at least one of the destination or the traveling route.

2. The system for guiding evacuation at a time of a disaster of claim 1, wherein the notification device is the display.

3. The system for guiding evacuation at a time of a disaster of claim 1, wherein the processor is configured to propose a plurality of destinations and a plurality of traveling routes.

4. The system for guiding evacuation at a time of a disaster of claim 1, further comprising an external server that communicates wirelessly with another vehicle,
wherein the processor is configured to:
cause vehicle information, which is at least one of sensor information acquired by a sensor provided at the other vehicle or operation information of a movable device provided at the other vehicle, to be transmitted by the wireless communicator to the external server by wireless communication, and
cause the notification device to notify the vehicle occupant of weather related information of a periphery of the another vehicle that is estimated on the basis of the vehicle information received by the external server.

5. The system for guiding evacuation at a time of a disaster of claim 4, wherein:
the sensor information includes at least one of image information acquired by a camera provided at the vehicle or information relating to slip ratios of wheels of the vehicle that is acquired on the basis of detected values of wheel speed sensors, and
the operation information includes at least one of operation information of a wiper device provided at the vehicle or operation information of an anti-lock brake system provided at the vehicle.

6. The system for guiding evacuation at a time of a disaster of claim 1, wherein the processor is configured to, after the destination and the traveling route have been proposed, newly propose the destination and the traveling route on the basis of information relating to occurrence of a disaster that the wireless communicator receives from the external communication device.

7. A method for guiding evacuation at a time of a disaster, wherein a processor:
proposes a traveling route to a destination of a vehicle in response to a wireless communicator installed in the vehicle receiving information relating to occurrence of a disaster from an external communication device;
causes a display installed in the vehicle to display the destination and the traveling route; and
causes a notification device installed in the vehicle to notify an occupant of the vehicle of information relating to a status of crowding of at least one of the destination or the traveling route.

8. A non-transitory computer-readable medium on which is recorded a program that is executable by a processor to perform processing that includes: in response to a wireless communicator installed at a vehicle receiving information relating to occurrence of a disaster from an external communication device, proposing a traveling route to a destination of the vehicle, and causing a display installed at the vehicle to display the destination and the traveling route, and causing a notification device installed at the vehicle to notify an occupant of the vehicle of information relating to a status of crowding of at least one of the destination or the traveling route.
